(19) United States
(12) Patent Application Publication
(10) Pub. No.: US 2024/0005224 A1
(43) Pub. Date: Jan. 4, 2024

(54) RECOMMENDATION DEVICE, RECOMMENDATION SYSTEM, RECOMMENDATION METHOD, PROGRAM AND STORAGE MEDIUM

(71) Applicant: NEC Corporation, Minato-ku, Tokyo (JP)

(72) Inventor: Yasuhiro AJIRO, Tokyo (JP)

(73) Assignee: NEC Corporation, Minato-ku, Tokyo (JP)

(21) Appl. No.: 18/038,966

(22) PCT Filed: Nov. 27, 2020
(86) PCT No.: PCT/JP2020/044290

§ 371 Date: May 25, 2023

(51) Int. Cl. G06Q 10/0631

(52) U.S. Cl. CPC G06Q 10/0631

(57) ABSTRACT

Provided is a technology that enables a user to more easily determine validity of a recommended company recommended as a cooperation candidate of a target company. A recommendation device (100) includes: an extracting section (101) that extracts a recommended company recommended as a cooperation candidate of a target company, from a plurality of companies on the basis of target company information including a cooperation detail desired by the target company and cooperation candidate company information including a cooperation detail desired by each of the plurality of companies, which are cooperation candidates of the target company; a specifying section (102) that specifies a first important part in the target company information and a second important part in the cooperation candidate company information of the recommended company; and a presenting section (103) that presents the cooperation candidate company information of the recommended company, the first important part, and the second important part.

### TECHNICAL FIELD

The present invention relates to a technology for presenting a recommended company in accordance with a target company.

### BACKGROUND ART

Patent Literature 1 describes a technology for presenting a recommended company in accordance with a target company. The technology disclosed in Patent Literature 1 extracts, on the basis of a matching index such as a profit margin, a recommended company recommended as a business partner of a target company, and presents the extracted recommended company together with the matching index.

Non-Patent Literature 1 also describes a technology that is applicable when the recommended company is presented. The technology disclosed in Non-Patent Literature 1 predicts an evaluation value of a company by analyzing a text evaluating the company, and presents an important part included in the text and contributing to the prediction.

### CITATION LIST

### Patent Literature

### Patent Literature 1

Japanese Patent Application Publication, Tokukai, No. 2017-182243

### Non-Patent Literature

### Non-Patent Literature 1

Zhouhan Lin et. al., “A structured self-attentive sentence embedding”, ICLR 2017.

### SUMMARY OF INVENTION

### Technical Problem

With the technology disclosed in Patent Literature 1, a user cannot know information about the recommended company apart from the matching index. As such, the user may not able to obtain sufficient information about the recommended company presented, and thus may find it difficult to determine validity of the recommended company as a business partner. Further, in the case where the technology disclosed in Non-Patent Literature 1 is applied when the recommended company is presented, the important part in the text evaluating the recommended company may not necessarily be a part that is important for determining validity of the recommended company as a business partner. As such, the user may not be able to obtain sufficient information about the recommended company presented, and thus may find it difficult to determine validity of the recommended company.

An example aspect of the present invention is accomplished in view of the above problem. That is, an example object in accordance with an example aspect of the present invention is to provide a technology that enables a user to more easily determine validity of a recommended company recommended as a cooperation candidate of a target company.

### Solution to Problem

A recommendation device in accordance with an example aspect of the present invention includes: an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company; a specifying means that specifies a first important part in the target company information and a second important part in cooperation candidate company information of the recommended company; and a presenting means that presents the cooperation candidate company information of the recommended company, the first important part, and the second important part.

A recommendation method in accordance with an example aspect of the present invention includes steps carried out by a recommendation device, the steps being the steps of: extracting a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company; specifying a first important part in the target company information and a second important part in cooperation candidate company information of the recommended company; and presenting the cooperation candidate company information of the recommended company, the first important part, and the second important part.

A program in accordance with an example aspect of the present invention is a program for causing a computer to function as a recommendation device, the program causing the computer to function as: an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company; a specifying means that specifies a first important part in the target company information and a second important part in cooperation candidate company information of the recommended company; and a presenting means that presents the cooperation candidate company information of the recommended company, the first important part, and the second important part.

A storage medium in accordance with an example aspect of the present invention is a storage medium storing therein a program for causing a computer to function as a recommendation device, the program causing the computer to function as: an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company; a specifying means that specifies a first important part in the target company information and a second important part in cooperation candidate company information of the recommended company; and a presenting means that presents the cooperation candidate company information of the recommended company, the first important part, and the second important part.

A recommendation system in accordance with an example aspect of the present invention includes a recommendation device and a user terminal, the recommendation device including: an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the target company being indicated by input information obtained by the user terminal, the plurality of companies being cooperation candidates of the target company; a specifying means that specifies a first important part in the target company information and a second important part in cooperation candidate company information of the recommended company; and a presenting means that presents, to the user terminal, the cooperation candidate company information of the recommended company, the first important part, and the second important part, the user terminal including: an input means that obtains the input information; and a displaying means that displays information presented by the presenting means.

### Advantageous Effects of Invention

According to an example aspect of the present invention, a user can more easily determine validity of a recommended company recommended as a cooperation candidate of a target company.

### BRIEF DESCRIPTION OF DRAWINGS

FIG. 1 is a block diagram illustrating a configuration of a recommendation device in accordance with a first example embodiment of the present invention.

FIG. 2 is a flowchart illustrating a flow of a recommendation method in accordance with the first example embodiment of the present invention.

FIG. 3 is a block diagram illustrating a configuration of a recommendation system in accordance with a second example embodiment of the present invention.

FIG. 4 is a flowchart illustrating a flow of a recommendation method in accordance with the second example embodiment of the present invention.

FIG. 5 is a block diagram illustrating a configuration of a recommendation system in accordance with a third example embodiment of the present invention.

FIG. 6 is a view illustrating a specific example of a need information database in the third example embodiment of the present invention.

FIG. 7 is a flowchart illustrating a flow of a recommendation method in accordance with the third example embodiment of the present invention.

FIG. 8 is a view illustrating an example screen displayed in the third example embodiment of the present invention.

FIG. 9 is a block diagram illustrating a configuration of a recommendation system in accordance with a fourth example embodiment of the present invention.

FIG. 10 is a view illustrating a specific example of a company information database in the fourth example embodiment of the present invention.

FIG. 11 is a flowchart illustrating a flow of a recommendation method in accordance with the fourth example embodiment of the present invention.

FIG. 12 is a view illustrating an example screen displayed in the fourth example embodiment of the present invention.

FIG. 13 is a block diagram illustrating a configuration of a recommendation system in accordance with a fifth example embodiment of the present invention.

FIG. 14 is a flowchart illustrating a flow of a recommendation method in accordance with the fifth example embodiment of the present invention.

FIG. 15 is a view illustrating an example screen displayed in the fifth example embodiment of the present invention.

FIG. 16 is a view illustrating another example screen displayed in the fifth example embodiment of the present invention.

FIG. 17 is a block diagram illustrating an example of a hardware configuration of a recommendation device in accordance with each of the example embodiments of the present invention.

### EXAMPLE EMBODIMENTS

### First Example Embodiment

The following will discuss in detail a first example embodiment of the present invention, with reference to drawings. The present example embodiment is a basic form of example embodiments described later.

<Configuration of Recommendation Device>

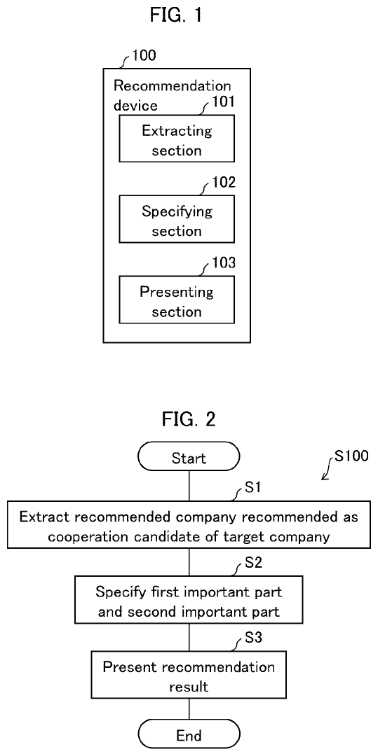

A recommendation device 100 in accordance with the present example embodiment is a device that presents a recommended company in accordance with a target company. The following will discuss a configuration of the recommendation device 100, with reference to FIG. 1. FIG. 1 is a block diagram illustrating a configuration of the recommendation device 100.

As illustrated in FIG. 1, the recommendation device 100 includes an extracting section 101, a specifying section 102, and a presenting section 103. The extracting section 101 is configured to realize an extracting means in the present example embodiment. The specifying section 102 is configured to realize a specifying means in the present example embodiment. The presenting section 103 is configured to realize a presenting means in the present example embodiment.

The extracting section 101 extracts a recommended company which is recommended as a cooperation candidate of a target company, from a plurality of companies on the basis of (i) target company information, which includes a cooperation detail desired by the target company and (ii) cooperation candidate company information, which includes a cooperation detail desired by each of the plurality of companies, which are cooperation candidates of the target company. The target company information and the cooperation candidate company information can be stored in a storage device included in the recommendation device 100 or can be stored in an external device communicatively connected to the recommendation device 100. For example, the extracting section 101 extracts, as the recommended company from the plurality of companies, a company that has cooperation candidate company information similar to the target company information. As a technique for determining similarity between pieces of information, a well-known technique can be employed. Note that a process of extracting the recommended company from the plurality of companies is not limited to the one described above.

A cooperation detail that is desired is a description of business in which a company seeks cooperation with another company. For example, a cooperation detail that is desired includes a feature of a company desired as a cooperation partner. A cooperation detail that is desired can include at least one selected from the group consisting of a name of the company, a description of business of the company, a service provided by the company, a product provided by the company, and a corporate philosophy of the company.

The specifying section 102 specifies a first important part in the target company information and a second important part in the cooperation candidate company information of the recommended company. The specifying section 102 may specify a single first important part or a plurality of first important parts. The specifying section 102 may specify a single second important part or a plurality of second important parts. For example, the specifying section 102 may specify, as a first important part, a part that is included in the target company information and has a level of importance not less than a threshold, and specify, as a second important part, a part that is included in the cooperation candidate company information and has a level of importance not less than a threshold. As a technique for determining a level of importance of a part included in information, for example, a well-known technique such as one described later can be applied. Note that a process of specifying the first important part and the second important part is not limited to the one described above.

The presenting section 103 presents the cooperation candidate company information of the recommended company, the first important part, and the second important part. Hereinafter, information presented by the presenting section 103 is also referred to as a “recommendation result”. The presenting section 103, for example, presents the recommendation result to a user. For example, the presenting section 103 displays, on a display device, a screen indicating the recommendation result. The display device can be included in the recommendation device 100 or can be an external device communicatively connected to the recommendation device 100. For example, the screen indicating the recommendation result includes the target company information and the cooperation candidate company information of the recommended company. The screen includes the first important part in the target company information and the second important part in the cooperation candidate company information, in respective display modes emphasizing the first important part and the second important part. Note that a process of presenting the recommendation result to a user is not limited to the one described above.

<Flow of Recommendation Method>

The following will discuss, with reference to FIG. 2, a flow of a recommendation method S100 carried out by the recommendation device 100 configured as described above. FIG. 2 is a flowchart illustrating a flow of the recommendation method S100. As illustrated in FIG. 2, the recommendation method S100 includes steps S1 to S3.

(Step S1)

In the step S1, the extracting section 101 extracts a recommended company from a plurality of companies on the basis of target company information and cooperation candidate company information of each of the plurality of companies.

(Step S2) In the step S2, the specifying section 102 specifies a first important part in the target company information and a second important part in cooperation candidate company information.

(Step S3)

In the step S3, the presenting section 103 presents a recommendation result including the cooperation candidate company information of the recommended company, the first important part, and the second important part.

### Example Advantage of Present Example Embodiment

As described above, according to the present example embodiment, a first important part in target company information and a second important part in cooperation candidate company information of a recommended company are presented to a user. This allows the user to recognize the first important part and the second important part while contrasting the first important part with the second important part. As a result, the user can more easily determine, by such contrasting, validity of the recommended company recommended as a cooperation candidate of the target company.

### Second Example Embodiment

The following will discuss in detail a second example embodiment of the present invention, with reference to drawings. Note that any constituent element that is identical in function to a constituent element described in the first example embodiment will be given the same reference numeral, and a description thereof will not be repeated.

<Configuration of Recommendation System>

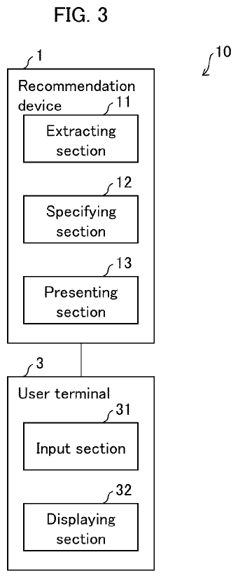

A recommendation system 10 in accordance with the present example embodiment is a system that presents a recommended company in accordance with a target company. The following will discuss a configuration of the recommendation system 10, with reference to FIG. 3. FIG. 3 is a block diagram illustrating a configuration of the recommendation system 10.

As illustrated in FIG. 3, the recommendation system 10 includes a recommendation device 1 and a user terminal 3. The recommendation device 1 and the user terminal 3 are communicatively connected to each other.

(Configuration of Recommendation Device)

As illustrated in FIG. 3, the recommendation device 1 includes an extracting section 11, a specifying section 12, and a presenting section 13. The extracting section 11 is configured to realize an extracting means in the present example embodiment. The specifying section 12 is configured to realize a specifying means in the present example embodiment. The presenting section 13 is configured to realize a presenting means in the present example embodiment.

The extracting section 11 is configured substantially similarly as the extracting section 101 in accordance with the first example embodiment, and differs from the extracting section 101 in receiving, from the user terminal 3, input information indicative of a target company among a plurality of companies. In other respects, the extracting section 11 is configured similarly as the extracting section 101, and detailed descriptions thereof will not be repeated.

The specifying section 12 is configured similarly as the specifying section 102 in accordance with the first example embodiment, and detailed descriptions thereof will not be repeated.

The presenting section 13 is configured substantially similarly as the presenting section 103 in accordance with the first example embodiment, and differs from the presenting section 103 in presenting a recommendation result to the user terminal 3. Specifically, the presenting section 13 presents the recommendation result to the user terminal 3 by transmitting the recommendation result to the user terminal 3. In other respects, the presenting section 13 is configured similarly as the presenting section 103, and detailed descriptions thereof will not be repeated.

(Configuration of User Terminal)

As illustrated in FIG. 3, the user terminal 3 includes an input section 31 and a displaying section 32. The input section 31 is configured to realize an input means in the present example embodiment. The displaying section 32 is configured to realize a displaying means in the present example embodiment. The user terminal 3 is connected to an input device and a display device (both not illustrated).

The input section 31 obtains, through the input device, input information indicative of a target company among a plurality of companies. The input section 31 transmits the input information obtained to the recommendation device 1.

The displaying section 32 displays, on the display device, a recommendation result presented from the recommendation device 1.

<Flow of Recommendation Method>

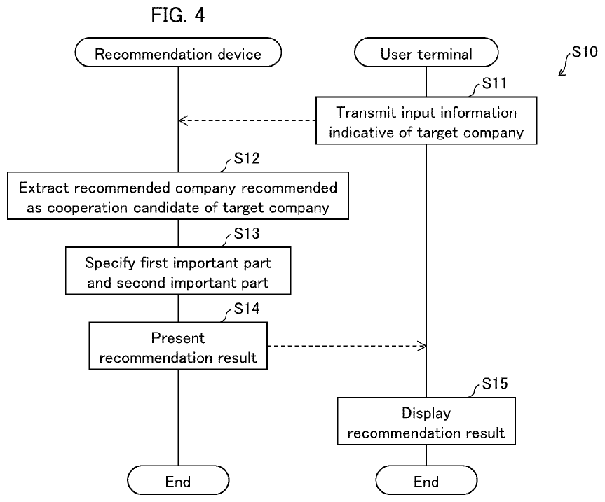

The following will discuss, with reference to FIG. 4, a flow of a recommendation method S10 carried out by the recommendation system 10 configured as described above. FIG. 4 is a flowchart illustrating a flow of the recommendation method S10. As illustrated in FIG. 4, the recommendation method S10 includes steps S11 to S15.

(Step S11)

In the step S11, the input section 31 of the user terminal 3 obtains input information indicative of a target company among a plurality of companies. The input section 31 transmits the input information obtained to the recommendation device 1.

(Step S12)

In the step S12, the extracting section 11 of the recommendation device 1 extracts a recommended company from a plurality of companies on the basis of target company information and cooperation candidate company information of each of the plurality of companies.

(Step S13)

In the step S13, the specifying section 12 specifies a first important part in the target company information and a second important part in cooperation candidate company information.

(Step S14)

In the step S14, the presenting section 13 presents a recommendation result including cooperation candidate company information of the recommended company, the first important part, and the second important part. Specifically, the presenting section 13 presents the recommendation result to the user terminal 3 by transmitting the recommendation result to the user terminal 3.

(Step S15)

In the step S15, the displaying section 32 of the user terminal 3 displays, on the display device, the recommendation result presented from the recommendation device 1.

### Example Advantage of Present Example Embodiment

With the above configuration, the present example embodiment allows a user of the user terminal to recognize, by inputting information indicative of a target company, a first important part in target company information and a second important part in cooperation candidate company information of a recommended company while contrasting the first important part with the second important part. This allows the user to more easily determine validity of the recommended company in accordance with the target company.

### Third Example Embodiment

The following will discuss in detail a third example embodiment of the present invention, with reference to drawings. Note that any constituent element that is identical in function to a constituent element described in the first example embodiment or the second example embodiment will be given the same reference numeral, and a description thereof will not be repeated.

<Configuration of Recommendation System>

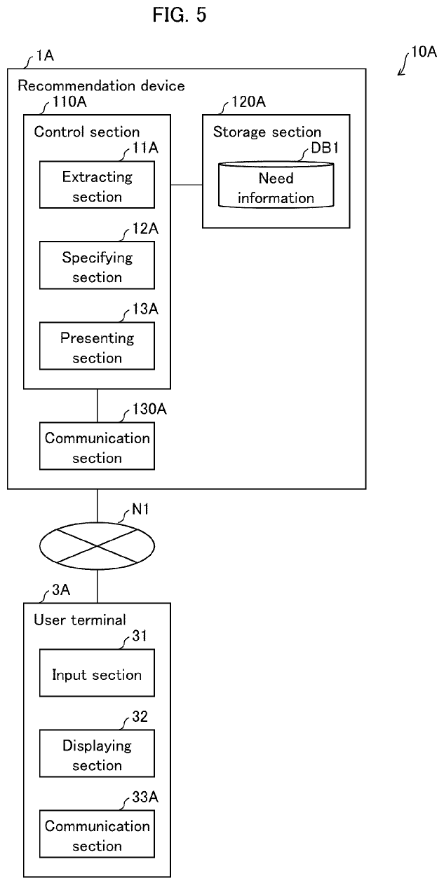

A recommendation system 10A in accordance with the present example embodiment is a system in which a recommended company is presented in accordance with a target company, with reference to a need text registered by each of a plurality of companies. The recommendation system 10A includes, in a recommendation result recommending a recommended company, a correspondence between a first important part pertaining to the target company and a second important part pertaining to the recommended company, and presents the recommendation result to a user. The following will discuss a configuration of the recommendation system 10A, with reference to FIG. 5. FIG. 5 is a block diagram illustrating a configuration of the recommendation system 10A.

As illustrated in FIG. 5, the recommendation system 10A includes a recommendation device 1A and a user terminal 3A. The recommendation device 1A and the user terminal 3A are communicatively connected to each other via a network N1. Note that although FIG. 5 illustrates a single user terminal 3A, the number of user terminals 3A to which the recommendation device 1A is connected is not limited. The network N1 is, for example, a wireless local area network (LAN), a wired LAN, a wide area network (WAN), a public network, a mobile data communication network, or a combination of these networks. Note that a configuration of the network N1 is not limited to these examples.

(Configuration of User Terminal)

As illustrated in FIG. 5, the user terminal 3A includes a communication section 33A in addition to the configurations similar to those of the user terminal 3 in accordance with the second example embodiment.

The communication section 33A transmits and receives information to and from the recommendation device 1A via the network N1. Hereinafter, a case where the communication section 33A transmits and receives information to and from the recommendation device 1A may be simply referred to as a case where the user terminal 3A transmits and receives information to and from the recommendation device 1A.

(Configuration of Recommendation Device)

As illustrated in FIG. 5, the recommendation device 1A includes a control section 110A, a storage section 120A, and a communication section 130A. The control section 110A includes an extracting section 11A, a specifying section 12A, and a presenting section 13A. The extracting section 11A is configured to realize an extracting means in the present example embodiment. The specifying section 12A is configured to realize a specifying means in the present example embodiment. The presenting section 13A is configured to realize a presenting means in the present example embodiment. Details of these functional blocks included in the control section 110A will be described later.

The storage section 120A stores therein a need information database DB1. Details of the need information database DB1 will be described later. The storage section 120A is configured to realize a storage device in the present example embodiment.

The communication section 130A transmits and receives information to and from the user terminal 3A via the network N1, under the control of the control section 110A. Hereinafter, a case where the control section 110A transmits and receives information to and from the user terminal 3A via the communication section 130A may simply be referred to as a case where the control section 110A transmits and receives information to and from the user terminal 3A.

(Need Information Database)

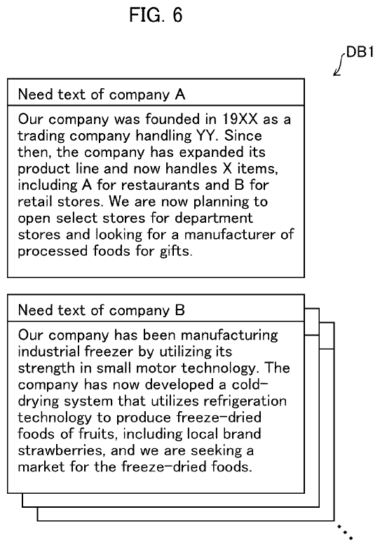

The following will discuss a configuration of the need information database DB1, with reference to FIG. 6. FIG. 6 is a view illustrating a specific example of the need information database DB1. As illustrated in FIG. 6, the need information database DB1 stores therein, for each of a plurality of companies, information including a need text. The need text of each company in the present example embodiment is an example of “target company information” and “cooperation candidate company information” recited in Claims. The need text of each company includes a phrase indicative of a desired feature of a cooperation partner of the company. The need text of each company can include at least one selected from the group consisting of a name of the company, a description of business of the company, a service provided by the company, a product provided by the company, and a corporate philosophy of the company.

For example, in FIG. 6, the phrase “looking for a manufacturer of processed foods for gifts” included in a need text of a company A illustrates an example of a desired feature of a cooperation partner of the company A. Further, for example, the phrase “seeking a market for the freeze-dried foods” included in a need text associated with a company B illustrates an example of a desired feature of a cooperation partner of the company B.

(Company Having Need Text Registered)

Hereinafter, a company whose information including a need text is stored in the need information database DB1 is also referred to as a “company having a need text registered in the need information database DB1” or simply as a “company having a need text registered”. There can be a case in which a new need text of a company is additionally registered after the recommendation device 1A has started operating. Further, there can be a case in which a need text already registered is corrected after the recommendation device 1A has started operating. Further, there can be a case in which a need text of a company already registered is deleted after the recommendation device 1A has started operating.

(Plurality of Companies)

A “plurality of companies” means a plurality of companies each of which has a need text registered in the need information database DB1.

(Target Company)

A “target company” means a single company that is a target of matching among the plurality of companies. The target company is designated by a user of the recommendation device 1A.

(Recommended Company)

A “recommended company” means a company that is recommended as a cooperation partner of the target company among the plurality of companies.

(Candidate Company)

A “candidate company” means a company other than the target company among the plurality of companies. The candidate company is a company that serves as a candidate for a recommended company which is recommended in accordance with the target company. In other words, the candidate company is a company that serves as a cooperation candidate of the target company. For the single target company, there are one or more candidate companies.

(Configuration of Extracting Section)

The extracting section 11A refers to a need text of each company stored in the need information database DB1 and extracts, as recommended company(ies), one or more candidate companies each of which has a need text similar to that of the target company. Details of a method of determining similarity between need texts will be described later.

(Configuration of Specifying Section)

The specifying section 12A specifies, from the need text of the target company and a need text of a recommended company each, a phrase related to a business in which the target company seeks cooperation (hereinafter also referred to as an “important phrase”). That is, the specifying section 12A specifies a first important part, which is at least one important phrase in the need text of the target company, and a second important part, which is at least one important phrase in a need text of a recommended company. The specifying section 12A also specifies a correspondence between each first important part and each second important part. Details of a method of specifying each first important part, each second important part, and a correspondence therebetween will be described later.

Note that the need text of the target company in the present example embodiment is an example of “target company information” recited in Claims. Further, a need text of a candidate company in the present example embodiment is an example of “cooperation candidate company information” recited in Claims.

(Configuration of Presenting Section)

The presenting section 13A presents a recommendation result to the user terminal 3A on the basis of a correspondence specified by the specifying section 12A. The recommendation result includes, in addition to content similar to that of the recommendation result in the second example embodiment, information indicative of a correspondence between a first important part and a second important part.

<Flow of Recommendation Method>

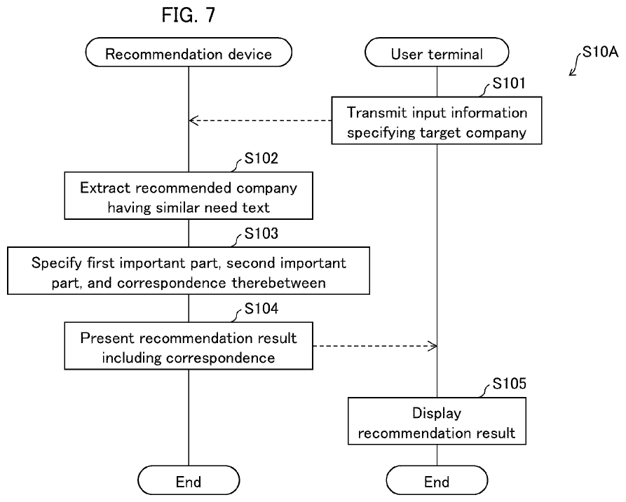

The following will discuss, with reference to FIG. 7, a flow of a recommendation method S10A carried out by the recommendation system 10A configured as described above. FIG. 7 is a flowchart illustrating a flow of the recommendation method S10A. As illustrated in FIG. 7, the recommendation method S10A includes steps S101 to S105.

(Step S101)

In the step S101, the input section 31 of the user terminal 3A obtains, through the input device, input information indicative of a target company among a plurality of companies each having a need text registered. The input section 31 transmits the input information obtained to the recommendation device 1A.

(Step S102)

In the step S102, the extracting section 11A refers to a need text of each company and extracts, as a recommended company(ies), one or more candidate companies each of which has a need text similar to that of the target company indicated by the input information. A method of determining similarity between need texts can specifically be, for example, a (a) method based on interword distances, a (b) method based on an inter-document distance, or a (c) method based on a trained model. Details of these methods will be described below. Note that a method of determining similarity between need texts is not limited to these examples.

(a: Method Based on Interword Distances)

In a case where this method is employed, the extracting section 11A calculates a degree of similarity between the need text of the target company and a need text of each candidate company on the basis of interword distances. Specifically, the extracting section 11A calculates an interword distance for each combination of a word included in the need text of the target company and a word included in the need text of the candidate company. The extracting section 11A also calculates a degree of similarity between the need text of the target company and the need text of the candidate company, with use of interword distances thus calculated. Further, the extracting section 11A extracts, as a recommended company(ies), one or more candidate companies for each of which the calculated degree of similarity is not less than a threshold.

For example, the extracting section 11A calculates an interword distance for each combination of a word w1i (i=1, 2, . . . , n) included in the need text of the target company and a word w2j (j=1, 2, . . . , m) included in a need text of a candidate company. Note that n and m are natural numbers. In this case, there are n×m combinations of the word w1i and the word w2j. In other words, the extracting section 11A calculates n×m interword distances. In a case where a feature of each word w1i and a feature of each word w2j are expressed in the form of vectors, an interword distance can be represented by an angle between the two vectors or by a Euclidean distance between the vectors. As a technique for expressing a feature of a word in the form of a vector, it is possible to use a trained model which has been trained by machine learning so as to output a feature vector upon receiving input of a word. A technique such as word2vec can be employed as such a trained model, although the present invention is not limited thereto. The extracting section 11A calculates a degree of similarity between the need text of the target company and a need text of a candidate company, with use of a statistical value of interword distance. As a specific example, the extracting section 11A calculates the degree of similarity such that the degree of similarity increases as an average value of interword distances of all combinations of the word w1i and the word w2j decreases. As another specific example, the extracting section 11A calculates the degree of similarity such that the degree of similarity increases as an average value of the respective interword distances of a predetermined number of combinations among the all combinations decreases, the predetermined number of combinations being the top predetermined number of combinations ranked in ascending order of interword distances among the all combinations.

(b: Method Based on Inter-Document Distance)

In a case where this method is employed, the extracting section 11A calculates a degree of similarity between the need text of the target company and a need text of each candidate company on the basis of an inter-document distance. Further, the extracting section 11A extracts, as a recommended company(ies), one or more candidate companies for each of which the degree of similarity is not less than a threshold.

In a case where a feature of each need text is expressed in the form of a vector, an inter-document distance between need texts can be represented by an angle between two vectors or by a Euclidean distance between the vectors. As a technique for representing a feature of a need text in the form of a vector, it is possible to use a trained model that has been trained by machine learning so as to output a feature vector upon receiving input of a need text. A technique such as doc2vec can be employed as such a trained model, although the present invention is not limited thereto. The extracting section 11A calculates the degree of similarity such that the degree of similarity increases as the inter-document distance decreases.

(c: Method Based on Trained Model)

In a case where this method is employed, the extracting section 11A uses a trained model that has been trained by machine learning so as to output information indicative of similarity between respective need texts of two companies, upon receiving input of the need texts. The extracting section 11A inputs the need text of the target company and a need text of a candidate company into the trained model. Further, the extracting section 11A extracts, as a recommended company(ies), one or more candidate companies for each of which “information indicative of similarity” is outputted from the trained model.

For example, the extracting section 11A generates the trained model in advance by machine learning in the following manner. The extracting section 11A uses, as training data, respective need texts of two companies that have had an actual case of matching therebetween among a plurality of companies, and carries out training so that the trained model outputs, upon receiving input of these need texts, information indicative of similarity between the need texts. Further, for example, the extracting section 11A carries out training so that the trained model outputs, upon receiving input of respective need texts of two companies that have never had a case of matching therebetween, information indicative of non-similarity between the need texts. For example, the extracting section 11A may generate the trained model by transfer learning or fine tuning with use of a pre-trained model. Specific examples of the pre-trained model include, but are not limited to, bidirectional encoder representations from transformers (BERT) and the like. Note that the trained model can have been trained to output a degree of similarity, instead of outputting information indicative of whether or not there is similarity. In this case, the extracting section 11A extracts, as a recommended company(ies), one or more candidate companies for each of which a degree of similarity not less than a threshold is outputted.

(Step S103)

In the step S103, the specifying section 12A specifies at least one first important part in the need text of the target company and at least one second important part in a need text of each recommended company. The specifying section 12A also specifies a correspondence between each first important part and each second important part. Note that in order to specify the “correspondence between each first important part and each second important part”, the specifying section 12A specifies, out of combinations of a first important part and a second important part, a combination of a first important part and a second important part having a correspondence therebetween.

Note that a method of specifying each first important part, each second important part, and a correspondence therebetween can specifically be, for example, a (d) method based on interword distances, a (e) method based on levels of importance of words, or a (f) method based on a part to which a trained model pays attention. Details of these methods will be described below. Note that the method of specifying each first important part, each second important part, and a correspondence therebetween is not limited to these examples.

(d: Method Based on Interword Distances)

This method is preferably applied in a case where the extracting section 11A uses the “(a) method based on interword distances” in the step S102. In a case where this method is employed, the specifying section 12A specifies each first important part and each second important part in the need text of the recommended company on the basis of an interword distance between each word included in the need text of the target company and each word included in the need text of the recommended company. In so doing, the specifying section 12A may refer to, as an interword distance of each combination of words, a value calculated by the extracting section 11A in the method (a).

For example, the specifying section 12A determines that, in a combination of words having an interword distance not more than a threshold, the word included in the need text of the target company is an important word in the need text of the target company. The specifying section 12A also determines that, in the combination of words having the interword distance not more than the threshold, the word included in the need text of the recommended company is an important word in the need text of the recommended company.

Further, for example, the specifying section 12A calculates, for each constituent unit of the need text of the target company, a score based on an important word included in the each constituent unit, and determines that a constituent unit whose score thus calculated is not less than a threshold is a first important part. Further, for example, the specifying section 12A calculates, for each constituent unit of the need text of the recommended company, a score based on an important word included in the each constituent unit, and determines that a constituent unit whose score thus calculated is not less than a threshold is a second important part. Note that specific examples of a constituent unit include, but are not limited to, a phrase or a paragraph. Specific examples of a score include, but are not limited to, a value based on the number of important words included.

Further, the specifying section 12A specifies, as a combination of a first important part and a second important part having a correspondence therebetween from among combinations of a first important part and a second important part, a combination whose statistical value of interword distances between important words contained in the combination is not more than a threshold.

(e: Method Based on Levels of Importance of Words)

This method is preferably applied in a case where the extracting section 11A uses the “(b) method based on an inter-document distance” or the “(c) method based on a trained model” in the step S102.

In a case where this method is employed, the specifying section 12A specifies each first important part and each second important part on the basis of a level of importance of each word included in each of the need text of the target company and the need text of the recommended company. For example, the specifying section 12A calculates, for each constituent unit of the need text of the target company, a score on the basis of a level of importance of each word included in the each constituent unit, and determines that a constituent unit whose score thus calculated is not less than a threshold is a first important part. Further, for example, the specifying section 12A calculates, for each constituent unit of the need text of the recommended company, a score on the basis of a level of importance of each word included in the each constituent unit, and determines that a constituent unit whose score thus calculated is not less than a threshold is a second important part.

Further, in a case where a single first important part and a single second important part are specified, the specifying section 12A specifies the single first important part and the single second important part as having a correspondence therebetween.

In a case where a plurality of first important parts and/or a plurality of second important parts are specified, the specifying section 12A can regard each of the plurality of first important parts as a document and each of the plurality of second important parts as a document, and calculate an inter-document distance. In this case, the specifying section 12A specifies, as a combination of a first important part and a second important part having a correspondence therebetween from among combinations of a first important part and a second important part, a combination having an inter-document distance not more than a threshold.

Note that specific examples of a technique for calculating a level of importance of a word included in each need text include, but are not limited to, term frequency-inverse document frequency (TF-IDF). In a case where TF-IDF is used, a level of importance of a word included in a certain need text is calculated such that the level of importance increases as the word appears in the certain need text more frequently and as the word occurs only in a smaller number of need texts, including the certain need text, among a plurality of need texts.

(f: Method Based on Part to which Trained Model Pays Attention)

This method is preferably applied in a case where the extracting section 11A uses the “(b) method based on an inter-document distance” or the “(c) method based on a trained model” in the step S102.

In a case where this method is employed, the specifying section 12A specifies each first important part and each second important part on the basis of a part to which the trained model used in the “(b) method based on an inter-document distance” or the “(C) method based on a trained model” pays attention in each of an inputted need text of the target company and an inputted need text of the recommended company.

Specifically, the specifying section 12A determines, with use of an attention mechanism incorporated in the trained model, a degree of attention paid to each word included in each of the need texts inputted. Further, the extracting section 11A calculates, for each constituent unit of the need text of the target company, a score based on a degree of attention paid to a word included in the each constituent unit, and determines that a constituent unit whose score thus calculated is not less than a threshold is a first important part. Further, the extracting section 11A calculates, for each constituent unit of the need text of the recommended company, a score based on a degree of attention paid to a word included in the each constituent unit, and determines that a constituent unit whose score thus calculated is not less than a threshold is a second important part.

A method of specifying a correspondence in a case where a single first important part and a single second important part are specified is as described in “(e): Method based on levels of importance of words”. Further, a method of specifying a correspondence in a case where a plurality of first important parts and/or a plurality of second important parts are specified is as described in “(e): Method based on levels of importance of words”.

(Step S104)

In the step S104, the presenting section 13A presents a recommendation result to the user terminal 3A. The recommendation result includes information indicative of a recommended company, a first important part, a second important part, and information indicative of a correspondence between the first important part and the second important part. Specifically, the presenting section 13A generates screen data indicating the recommendation result. The presenting section 13A presents the recommendation result to the user terminal 3A by transmitting the screen data to the user terminal 3A.

Specifically, the presenting section 13A generates screen data including the need text of the target company and the need text of the recommended company. In the need text of the target company included in the screen data, the presenting section 13A causes a difference between a display mode of the first important part and a display mode of a part other than the first important part. In the need text of the recommended company included in the screen data, the presenting section 13A causes a difference between a display mode of the second important part and a display mode of a part other than the second important part. The presenting section 13A may cause a display mode of the first important part and a display mode of the second important part to correspond to each other in the screen data. Specifically, to each combination of a first important part and a second important part having a correspondence therebetween, the presenting section 13A may apply a display mode that differs among such combinations. Details of such screen data will be described later.

(Step S105)

In the step S105, the displaying section 32 of the user terminal 3A displays the recommendation result presented from the recommendation device 1A. Specifically, the displaying section 32 displays, on a display device, the screen data received from the recommendation device 1A. An example screen displayed on the user terminal 3A in the present step will be described below.

<Example Screen>

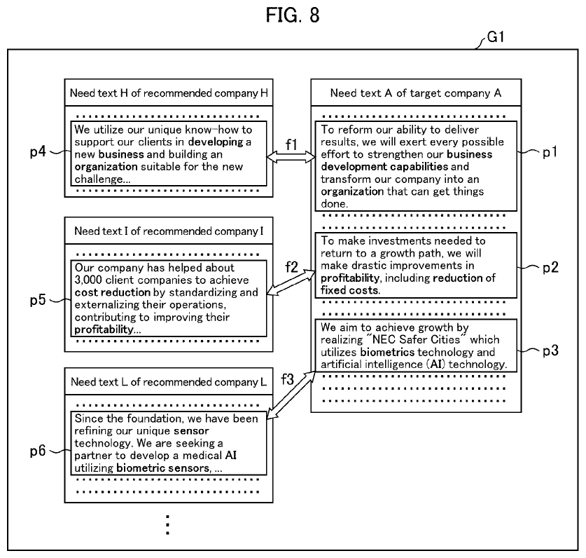

The following will discuss, with reference to FIG. 8, an example screen displayed by the recommendation system 10A in the step S105. FIG. 8 illustrates an example screen G1 of the recommendation result. As illustrated in FIG. 8, the example screen G1 includes a need text A of a company A, which is a target company, and need texts H, I, and L of companies H, I, and L, which are recommended companies.

In the need text A of the company A, first important parts p1 to p3 are specified. In the need text H of the company H, a second important part p4 is specified. In the need text I of the company I, a second important part p5 is specified. In the need text L of the company L, a second important part p6 is specified. The first important parts p1 to p3 and the second important parts p4 to p6 are each displayed in a display mode different from a display mode of the other part of a corresponding need text. In this example, a display mode in which an important part is enclosed by a rectangle is applied to important parts. The present invention, however, is not limited to such a display mode. For example, the first important parts p1 to p3 and the second important parts p4 to p6 can each be displayed in a display mode that is (i) any one selected from the group consisting of: a color different from that of the other part of a corresponding need text; a background color different from that of the other part of the corresponding need text; a font different from that of the other part of the corresponding need text; a size different from that of the other part of the corresponding need text; a luminance different from that of the other part of the corresponding need text; boldfacing; italicizing; underlining; blinking; and animation or (ii) a combination of at least two selected from the group.

Note that in the example screen G1, the display mode applied may differ among combinations of a first important part and a second important part in each of which the first important part and the second important part have a correspondence therebetween. For example, a rectangle enclosing the first important part p1 and a rectangle enclosing the second important part p4 may be red, a rectangle enclosing the first important part p2 and a rectangle enclosing the second important part p5 may be blue, and a rectangle enclosing the first important part p3 and a rectangle enclosing the second important part p6 may be yellow. Note that the present invention is not limited to such a configuration of the display mode differing among combinations of a first important part and a second important part in each of which the first important part and the second important part have a correspondence therebetween. For example, the display modes applied to the respective combinations can be: any one of respective different background colors, respective different fonts, respective different sizes, or respective different luminances; a combination of at least two thereof, or the like.

Boldfaced words in the need texts A, H, I, and L are words specified as important words in corresponding need texts. An important word is thus displayed in a display mode different from those of the other words. Note, however, that the display mode applied to an important word is not limited to boldfacing. For example, an important word can be displayed in a display mode that is (i) any one selected from the group consisting of: a color different from that of the other words; a background color different from that of the other words; a font different from that of the other words; a size different from that of the other words; a luminance different from that of the other words; italicizing; underlining; blinking; animation; and framing or (ii) a combination of at least two selected from the group.

The example screen G1 includes figures f1 to f3 each of which indicates a correspondence between a first important part and a second important part. In this example, the figures f1 to f3 are each a two-headed arrow. Note, however, that the figures f1 to f3 are each not limited to a two-headed arrow. For example, the figures f1 to f3 may each be a line other than an arrow, such as a broken line, a dot-dash line, a double line, a curve, or a free line. The figure f1 indicates that the first important part p1 and the second important part p4 have a correspondence therebetween. The figure f2 indicates that the first important part p2 and the second important part p5 have a correspondence therebetween. The figure f3 indicates that the first important part p3 and the second important part p6 have a correspondence therebetween.

The user can recognize, from the figure f1, that the second important part p4 in the need text H corresponds to the first important part p1 in the need text A of the company A. The user can also recognize, from the figure f2, that the second important part p5 in the need text I corresponds to the first important part p2 in the need text A. In this example, the first important parts p1 and p2 in the need text A each indicate a business policy of the company A and do not sufficiently represent a desired feature of a cooperation partner of the company A. In this case, the user can easily determine that the companies H and I, which include the second important parts p4 and p5 corresponding to the first important parts p1 and p2, have low validity as a cooperation partner of the company A.

The user can also recognize, from the figure f3, that the second important part p6 in the need text L corresponds to the first important part p3 in the need text A of the company A. The first important part p3 in the need text A sufficiently represents a desired feature of a cooperation partner of the company A. In this case, the user can easily determine that the company L, which includes the second important part p6 corresponding to the first important part p3, has high validity as a cooperation partner of the company A.

Note that in the above-described case where differing display modes are applied to respective combinations of a first important part and a second important part in each of which the first important part and the second important part have a correspondence therebetween, the example screen G1 need not include the figures f1 to f3. In this case, the user can easily recognize a correspondence between a first important part and a second important by visually recognizing the second important part in a display mode corresponding to a display mode of the first important part.

### Example Advantage of Present Example Embodiment

As described above, in the present example embodiment, information indicative of a correspondence between each first important part and each second important part is included in a recommendation result, and the recommendation result is presented to a user terminal. This allows a user to recognize which part of a need text of a target company corresponds to which part of a need text of a recommended company. As a result, the user can determine that a recommended company corresponding to a first important part that is included in the need text of the target company and more sufficiently represents a desired feature of a cooperation partner has higher validity as a cooperation partner. The user can also determine that a recommended company corresponding to a first important part that is included in the need text of the target company and does not sufficiently represent a desired feature of a cooperation partner has low validity. Thus, with use of the present example embodiment, a user can more easily determine validity of a recommended company in accordance with a target company.

### Fourth Example Embodiment

The following will discuss in detail a fourth example embodiment of the present invention, with reference to drawings. Note that any constituent element that is identical in function to a constituent element described in any one(s) of the first to third example embodiments will be given the same reference numeral, and a description thereof will not be repeated.

<Configuration of Recommendation System>

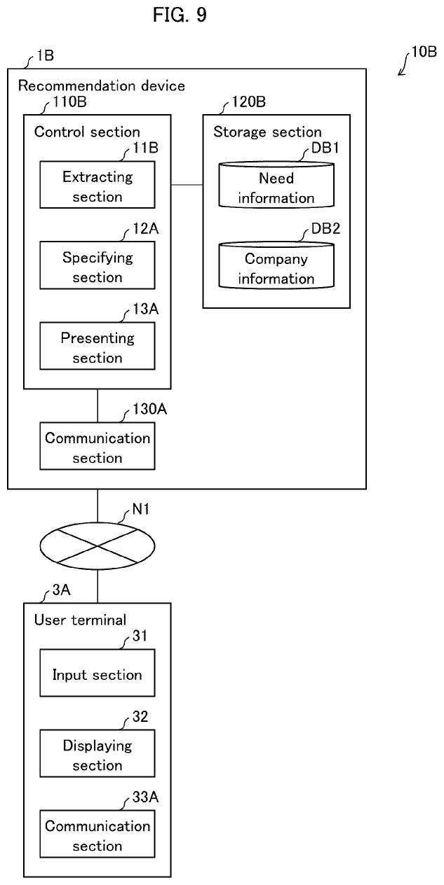

A recommendation system 10B in accordance with the present example embodiment is an example aspect obtained by modifying the third example embodiment. The recommendation system 10B presents, as a recommended company in accordance with a target company, a company that is highly unlikely to compete with the target company. The following will discuss a configuration of the recommendation system 10B, with reference to FIG. 9. FIG. 9 is a block diagram illustrating a configuration of the recommendation system 10B.

As illustrated in FIG. 9, the recommendation system 10B is configured substantially similarly as the recommendation system 10A in accordance with the third example embodiment, and differs from the recommendation system 10A in including a recommendation device 1B in place of the recommendation device 1A. In other respects, the recommendation system 10B is configured similarly as the recommendation system 10A.

(Configuration of Recommendation Device)

As illustrated in FIG. 9, the recommendation device 1B includes a control section 110B, a storage section 120B, and a communication section 130A.

The control section 110B is configured substantially similarly as the control section 110A in accordance with the third example embodiment, and differs from the control section 110A in including an extracting section 11B in place of the extracting section 11A. In other respects, the control section 110B is configured similarly as the control section 110A.

The storage section 120B is configured similarly as the storage section 120A in accordance with the third example embodiment, and further includes a company information database DB2.

(Company Information Database)

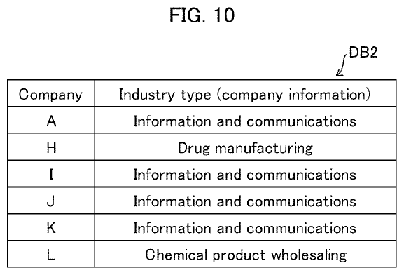

The following will discuss a configuration of the company information database DB2, with reference to FIG. 10. FIG. 10 is a view illustrating a specific example of the company information database DB2. As illustrated in FIG. 10, the company information database DB2 stores therein company information pertaining to each of a plurality of companies. For example, the company information includes information indicative of industry type. In an example illustrated in FIG. 10, information indicative of an industry type “information and communications” is stored as company information of each of companies A, I, J, and K. As company information of a company H, information indicative of an industry type “drug manufacturing” is stored. As company information of a company L, information indicative of an industry type “chemical product wholesaling” is stored. Note that company information can include, in place of or in addition to information indicative of industry type, other information pertaining to the company.

The extracting section 11B refers to the company information database DB2 and extracts, as a recommended company(ies) recommended in accordance with the target company, one or more candidate companies other than a competitor company of the target company. Details of a process of extraction will be described later.

<Flow of Recommendation Method>

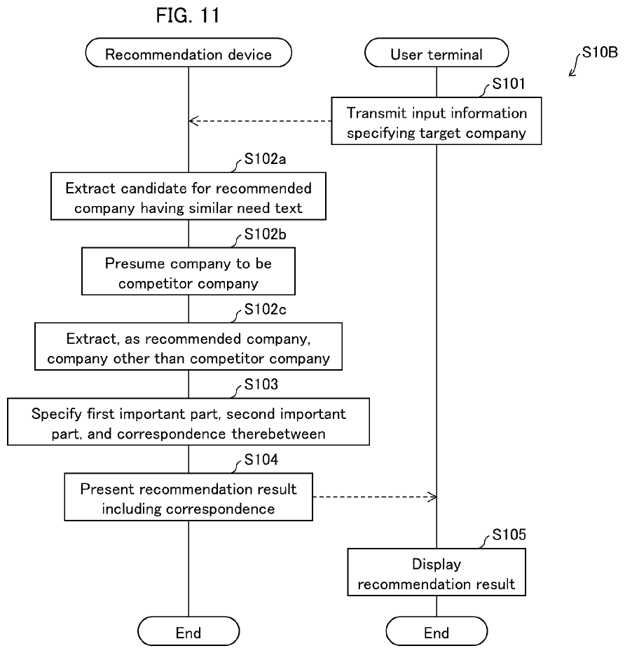

The following will discuss, with reference to FIG. 11, a flow of a recommendation method S10B carried out by the recommendation system 10B configured as described above. FIG. 11 is a flowchart illustrating a flow of the recommendation method S10B. As illustrated in FIG. 11, the recommendation method S10B is configured substantially similarly as the recommendation method S10A in accordance with the third example embodiment, and differs from the recommendation method S10A in including steps S102a to S102c in place of the step S102. The following description will discuss the steps S102a to S102c. The other steps are similar to those of the recommendation method S10A, and detailed descriptions thereof will not be repeated.

(Step S102a)

In the step S102a, the extracting section 11B of the recommendation device 1B extracts, as a candidate(s) for a recommended company recommended in accordance with a target company, one or more candidate companies each of which has a need text similar to that of the target company. Details of a process of extracting a candidate(s) for a recommended company in this step is similar to the details of the process of extracting a recommended company in the step S102 in accordance with the third example embodiment, and detailed descriptions thereof will not be repeated.

(Step S102b)

In the step S102b, the extracting section 11B refers to the company information database DB2 and presumes one or more companies among the candidate(s) for a recommended company to be a competitor company(ies) each competing with the target company.

### Specific Example of Process of Presuming Company to be Competitor Company

Specifically, the extracting section 11B refers to the company information database DB2 and presumes that a company that is in the same type of industry as the target company among the candidate(s) for a recommended company to be a competitor company. For example, assuming that the companies H, I, J, K, and L in the example of the company information database DB2 illustrated in FIG. 10 have been extracted as candidates for a recommended company of the company A, the extracting section 11B presumes the companies I, J, and K, which are in the same type of industry “information communications” as the company A, are competitor companies among the candidates for a recommended company.

Note that a method of presuming a company to be a competitor company with reference to company information is not limited to this method. For example, the extracting section 11B may use a trained model that has been trained to output a degree of competition upon receiving input of respective pieces of company information of two companies. In this case, the extracting section 11B inputs, to the trained model, company information of a target company and company information of a candidate for a recommended company, and presumes a candidate for which a degree of competition not less than a threshold is outputted to be a competitor company. In this case, each of the inputted pieces of company information include an industry type of the company, a description of business of the company, a description of business on which the company is focused, information of a business partner of the company, and/or the like.

(Step S102c)

In the step S102c, the extracting section 11B determines that the candidate(s) for a recommended company, excluding the competitor company(ies), are a recommended company(ies). In other words, the extracting section 11B extracts, each as a recommended company, a company(s) other than the competitor company(ies) among the candidate(s) for a recommended company.

Subsequently, the recommendation system 10B displays a recommendation result on a display device of a user terminal 3A by carrying out steps S103 to S105.

<Example Screen>

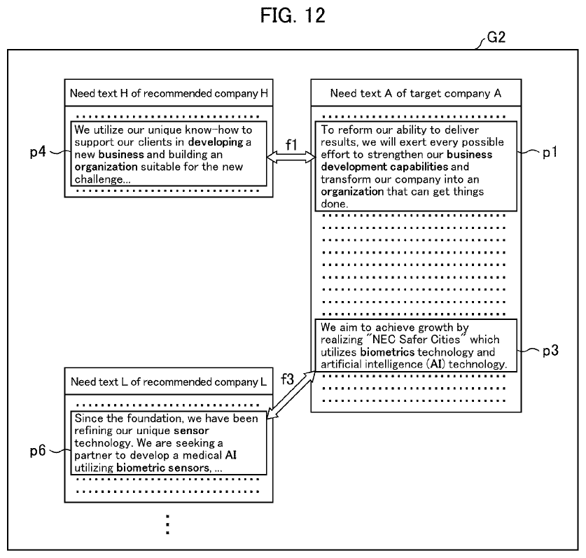

The following will discuss, with reference to FIG. 12, an example screen displayed by the recommendation system 10B in the step S105. FIG. 12 illustrates an example screen G2 of the recommendation result. As illustrated in FIG. 12, the example screen G2 includes a need text A of the company A, which is a target company, and need texts H and L of the companies H and L, which are recommended companies. The example screen G2 does not include a need text of the company I, which has been presumed to be a competitor company, among the recommended companies H, I, and L included in the example screen G1 in accordance with the second example embodiment. The example screen G2 includes figures f1 and f3 which respectively show (i) a correspondence between a first important part p1 in the need text of the target company A and a second important part p4 in the need text of the recommended company H and (ii) a correspondence between the first important part p1 in the need text of the target company A and a second important part p6 in the need text of the recommended company L.

### Example Advantage of Present Example Embodiment

As described above, in the present example embodiment, information indicative of a correspondence between each first important part and each second important part is included in a recommendation result recommending a recommended company other than a competitor company, and the recommendation result is presented. As such, in the present example embodiment, no correspondence between each first important part and each second important part is presented to a user with respect to a company that is highly likely a competitor company, even if the company has a need text similar to that of a target company. This allows the user to more easily determine validity of a recommended company which is presented.

In the example embodiment described above, a configuration has been described in which the needs information database DB1 and the company information database DB2 are separate databases. A configuration of the database is not limited to that indicated in the above example embodiment. Need texts and company information may be stored in a single database. In other words, company information stored in the company information database DB2 may include need texts and information pertaining to industry type. In this case, company information of each company stored in the company information database DB2 is an example of “target company information” and “cooperation candidate company information” recited in Claims.

### Fifth Example Embodiment

The following will discuss in detail a fifth example embodiment of the present invention, with reference to drawings. Note that any constituent element that is identical in function to a constituent element described in any one(s) of the first to fourth example embodiments will be given the same reference numeral, and a description thereof will not be repeated.

<Configuration of Recommendation System>

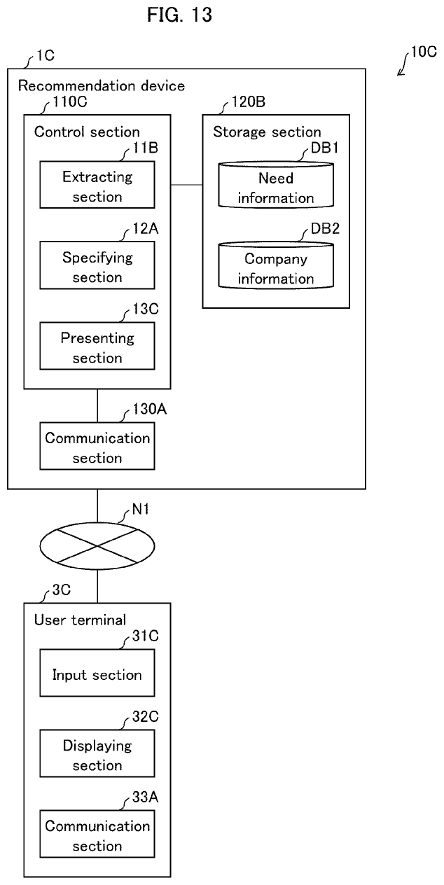

A recommendation system 10C in accordance with the present example embodiment is an example aspect obtained by modifying the fourth example embodiment. The recommendation system 10C presents candidates for a recommended company recommended in accordance with a target company, in classified form in which the candidates are classified into a competitor company and a company other than a competitor company. The following will discuss a configuration of the recommendation system 10C, with reference to FIG. 13. FIG. 13 is a block diagram illustrating a configuration of the recommendation system 10C.

As illustrated in FIG. 13, the recommendation system 10C includes a recommendation device 1C and a user terminal 3C.

(Configuration of Recommendation Device)

As illustrated in FIG. 13, the recommendation device 1C is configured substantially similarly as the recommendation device 1B in accordance with the fourth example embodiment, and differs from the recommendation device 1B in including a control section 110C in place of the control section 110B. The control section 110C is configured substantially similarly as the control section 110B in accordance with the fourth example embodiment, and differs from the control section 110B in including a presenting section 13C in place of the presenting section 13A. In other respects, the recommendation device 1C is configured similarly as the recommendation device 1B.

The presenting section 13C presents to the user terminal 3A candidates for a recommended company recommended in accordance with a target company, in classified form in which the candidates are classified into a competitor company and a company other than a competitor company. Details of a process of presenting the candidates in classified form will be described later.

(Configuration of User Terminal)

As illustrated in FIG. 13, the user terminal 3C includes an input section 31C and a displaying section 32C.

The input section 31C is configured similarly as the input section 31 in accordance with the fourth example embodiment, and further configured to transmit, to the recommendation device 1C, input information designating a recommended company. Details of a process of transmitting the input information will be described later.

The displaying section 32C is configured similarly as the displaying section 32 in accordance with the fourth example embodiment, and further configured to display candidates for a recommended company in classified form in which the candidates are classified into a competitor company and a company other than a competitor company. Details of a process of such displaying will be described later.

<Flow of Recommendation Method>

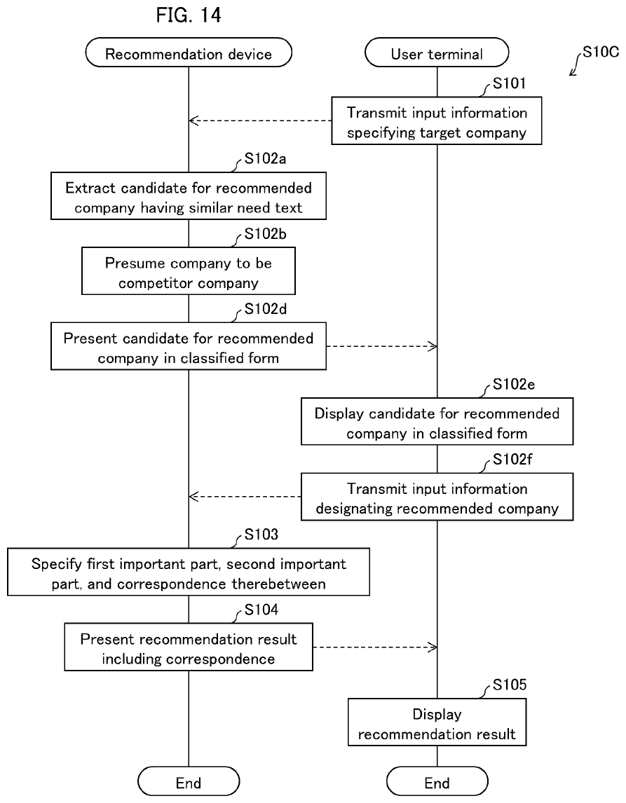

The following will discuss, with reference to FIG. 14, a flow of a recommendation method S10C carried out by the recommendation system 10C configured as described above. FIG. 14 is a flowchart illustrating a flow of the recommendation method S10C. As illustrated in FIG. 14, the recommendation method S10C is configured substantially similarly as the recommendation method S10B in accordance with the fourth example embodiment, and differs from the recommendation method S10B in including steps S102d to S102f in place of the step S102c. The following description will discuss the steps S102d to S102f. The other steps are similar to those of the recommendation method S10B, and detailed descriptions thereof will not be repeated.

(Step S102d)

In the step S102d, the presenting section 13C of the recommendation device 1C presents to the user terminal 3C candidates for a recommended company in classified form in which the candidates are classified into a competitor company and a company other than a competitor company. Specifically, the presenting section 13C generates screen data in which candidates for a recommended company extracted in a step S102a are classified into a company(s) presumed to be a competitor company(s) in a step S102b and a company(s) other than the competitor company(s). The presenting section 13C transmits the screen data to the user terminal 3C, thereby presenting the candidates to the user terminal 3C in classified form.

(Step S102e)

In the step S102e, the displaying section 32C of the user terminal 3C displays, on a display device, candidates for a recommended company recommended in accordance with a target company, in classified form in which the candidates are classified into a competitor company and a company other than a competitor company. Specifically, the displaying section 32 displays, on the display device, the screen data received from the recommendation device 1A.

(Step S102f)

In the step S102f, the input section 31C of the user terminal 3C obtains, through an input device, input information designating a recommended company. The input section 31C transmits the input information obtained to the recommendation device 1C. For example, a user uses the input device to carry out an operation of designating, as a recommended company(s), one or more of the candidates for a recommended company displayed in the step S102d.

Subsequently, the recommendation system 10C displays a recommendation result on the display device of the user terminal 3C by carrying out steps S103 to S105.

<Example Screen>

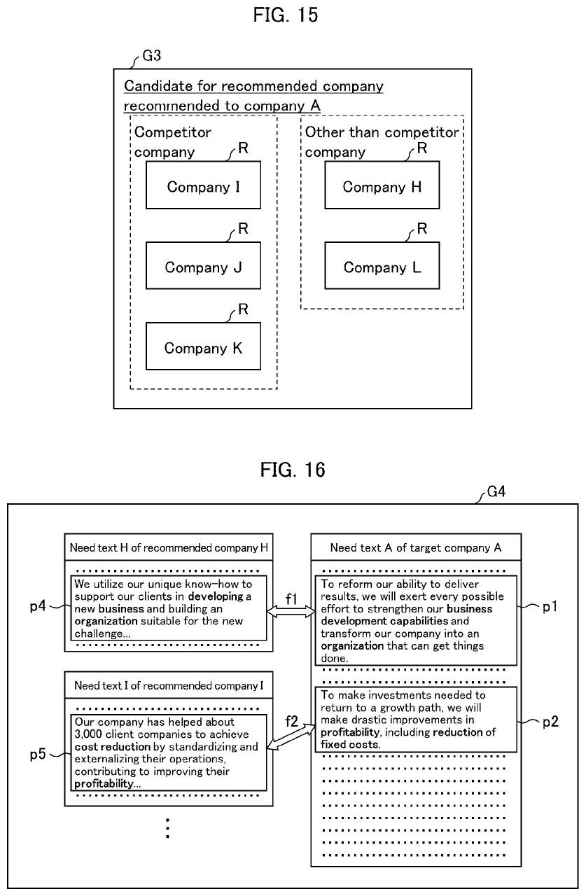

The following will discuss, with reference to FIGS. 15 and 16, example screens displayed by the recommendation system in the step S102e and the step S105.

(Example Screen Including Candidate for Recommended Company)

FIG. 15 is an example screen G3 of candidates for a recommended company displayed in the step S102e. As illustrated in FIG. 15, the example screen G3 includes regions R respectively indicating companies H, I, L, K, and L as candidates for a recommended company recommended to a company A, which is a target company. Of these, the respective regions R of the companies I, J, and K are enclosed by a frame for indicating a competitor company. The companies H and L are enclosed by a frame for indicating a company other than a competitor company. Thus, the companies H, I, L, K, and L, which are candidates for a recommended company, are displayed in classified form in which the companies H, I, L, K, and L are classified into a competitor company and a company other than a competitor company. Note that the frame for indicating a competitor company and the frame for indicating a company other than a competitor company are an example of a display mode in which classification into a competitor company and a company other than a competitor company is made. However, the present invention is not limited to such an example.

The displaying section 32C receives screen data indicating the example screen G3 from the recommendation device 1C and displays the received screen data on the display device. Each region R receives an operation carried out with the input device. The user carries out, with use of the input device, an operation of designating one or more of the displayed plurality of regions R, thereby designating, as a recommended company, a company indicated by each of the one or more of the plurality of regions R. The input section 31 obtains input information indicative of one or more recommended companies thus designated, and transmits the input information obtained to the recommendation device 1C. In this example, it is assumed that the user carries out an operation of designating, each as a recommended company, the company I classified as a competitor company and the company H classified as a company other than a competitor company.

(Example Screen of Recommendation Result)

FIG. 16 illustrates an example screen G4 of the recommendation result displayed in the step S105. As illustrated in FIG. 16, the example screen G4 includes a need text A of the company A, which is a target company. The example screen G4 also includes need texts of the companies H and I, which are recommended companies designated by the user. The company H is a company classified as a company other than a competitor company. The company I is a company classified as a competitor company. The example screen G4 includes figures f1 and f2 which respectively show (i) a correspondence between a first important part p1 in the need text of the company A and a second important part p4 in the need text of the company H and (ii) a correspondence between the first important part in the need text of the company A and a second important part p5 in the need text of the company I. As such, the user can designate, as a recommended company, the company I which the user wants to consider for a cooperation partner even though the company I is presumed to be a competitor company. This allows the user to visually recognize the respective need texts while contrasting the texts with each other.

### Example Advantage of Present Example Embodiment

As described above, in the present example embodiment, candidates for a recommended company recommended in accordance with a target company are displayed in classified form in which the candidates are classified into a competitor company and a company other than a competitor company. Then, in the present example embodiment, with respect to the target company and a recommended company designated by the user from among the candidates for a recommended company, information indicative of a correspondence between each first important part and each second important part is presented to the user. As such, with respect to a company which the user wants to consider for a cooperation partner even though the company is presumed to be a competitor company, the user can browse need texts while contrasting the need texts with each other. This allows the user to more easily determine validity of a recommended company.

### Software Implementation Example

Some or all of the functions of the recommendation devices 1, 1A, 1B, and 1C can be realized by hardware such as an integrated circuit (IC chip) or can be alternatively realized by software.

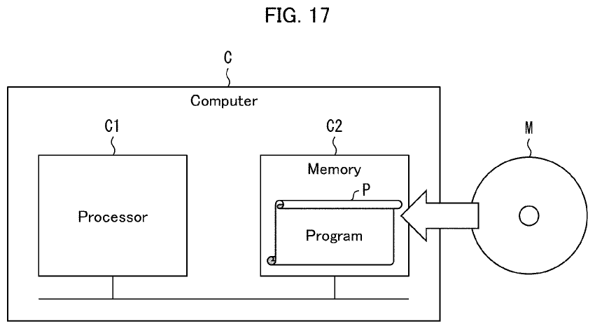

In the latter case, the recommendation devices 1, 1A, 1B, and 1C are realized by, for example, a computer that executes instructions of a program that is software realizing the foregoing functions. FIG. 17 illustrates an example of such a computer (hereinafter referred to as “computer C”). The computer C includes at least one processor C1 and at least one memory C2. The memory C2 stores a program P for causing the computer C to function as the recommendation devices 1, 1A, 1B, and 1C. In the computer C, the processor C1 reads the program P from the memory C2 and executes the program P, so that the functions of the recommendation devices 1, 1A, 1B, and 1C are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other devices. The computer C can further include an input-output interface for connecting input-output devices such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some or all of the above example embodiments can be described as below. Note, however, that the present invention is not limited to example aspects described below.

(Supplementary Note 1)

A recommendation device, including:
an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
a specifying means that specifies a first important part in the target company information and a second important part in cooperation candidate company information of the recommended company; and
a presenting means that presents the cooperation candidate company information of the recommended company, the first important part, and the second important part.

With the above configuration, a first important part in target company information and a second important part in cooperation candidate company information of a recommended company are presented to a user. This allows the user to recognize the first important part and the second important part while contrasting the first important part with the second important part. As a result, the user can more easily determine, by such contrasting, validity of a recommended company recommended as a cooperation candidate of a target company.

(Supplementary Note 2)

The recommendation device as set forth in supplementary note 1, wherein:
the specifying means specifies a correspondence between the first important part and the second important part; and
the presenting means further presents information indicative of the correspondence.

With the above configuration, a user can recognize a correspondence between a first important part and a second important part. This allows the user to more easily determine validity of a recommended company recommended as a cooperation candidate of a target company.

(Supplementary Note 3)

The recommendation device as set forth in supplementary note 1 or 2, wherein the cooperation detail includes at least one selected from the group consisting of a name of the company, a description of business of the company, a service provided by the company, a product provided by the company, and a corporate philosophy of the company.

With the above configuration, a user can more easily determine validity, as a cooperation partner, of a recommended company recommended as a cooperation candidate of a target company.

(Supplementary Note 4)

The recommendation device as set forth in any one of supplementary notes 1 through 3, wherein the specifying means specifies the first important part and the second important part on the basis of an interword distance between each word included in the target company information and each word included in the cooperation candidate company information.

The above configuration makes it possible to present, to a user, a first important part and a second important part that are specified so as to reflect an interword distance between target company information and cooperation candidate company information.

(Supplementary Note 5)

The recommendation device as set forth in any one of supplementary notes 1 through 3, wherein the specifying means specifies the first important part and the second important part on the basis of a level of importance of each word included in the target company information and a level of importance of each word included in the cooperation candidate company information.

The above configuration makes it possible to present, to a user, a first important part and a second important part that are specified so as to reflect levels of importance in the respective pieces of information.

(Supplementary Note 6)

The recommendation device as set forth in any one of supplementary notes 1 through 3, wherein:
the extracting means extracts the recommended company with reference to information outputted from a trained model that receives input of the target company information and the cooperation candidate company information; and
the specifying means specifies the first important part and the second important part on the basis of a part to which the trained model pays attention in the target company information and a part to which the trained model pays attention in the cooperation candidate company information.

The above configuration makes it possible to present, to a user, a first important part and a second important part each reflecting a part to which attention is paid when the recommended company is extracted.

(Supplementary Note 7)

The recommendation device as set forth in any one of supplementary notes 1 through 6, wherein the extracting means extracts, as the recommended company, a company other than a competitor company of the target company, with reference to company information of each of the plurality of companies.

With the above configuration, neither a first important part nor a second important part is presented to a user with respect to a company that is highly likely a competitor company, even if the company has a cooperation detail similar to that of a target company. This allows the user to more easily determine validity of a recommended company which is presented.

(Supplementary Note 8)

The recommendation device as set forth in any one of supplementary notes 1 through 7, wherein the presenting means displays the target company information and the cooperation candidate company information on a display device such that (i) the first important part and a part other than the first important part are displayed in respective different display modes in the target company information and (ii) the second important part and a part other than the second important part are displayed in respective different display modes in the cooperation candidate company information.

The above configuration allows a user to more easily recognize that a first important part and a second important part are important parts different from the other parts.

(Supplementary Note 9)

The recommendation device as set forth in any one of supplementary notes 1 through 8, wherein the presenting means displays the first important part and the second important part on a display device such that a display mode of the first important part and a display mode of the second important part correspond to each other.

The above configuration allows a user to more easily recognize each first important part and each second important part while associating the first important part and the second important part to each other.

(Supplementary Note 10)

A recommendation method, including steps carried out by a recommendation device, the steps being the steps of:
extracting a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
specifying a first important part in the target company information and a second important part in cooperation candidate company information of the recommended company; and
presenting the cooperation candidate company information of the recommended company, the first important part, and the second important part.

The above configuration makes it possible to obtain an effect similar to the effect of supplementary note 1.

(Supplementary Note 11)

A program for causing a computer to function as a recommendation device,
the program causing the computer to function as:
an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
a specifying means that specifies a first important part in the target company information and a second important part in cooperation candidate company information of the recommended company; and
a presenting means that presents the cooperation candidate company information of the recommended company, the first important part, and the second important part.

The above configuration makes it possible to obtain an effect similar to the effect of supplementary note 1.

(Supplementary Note 12)

A storage medium storing therein a program for causing a computer to function as a recommendation device,
the program causing the computer to function as:
an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
a specifying means that specifies a first important part in the target company information and a second important part in cooperation candidate company information of the recommended company; and
a presenting means that presents the cooperation candidate company information of the recommended company, the first important part, and the second important part.

The above configuration makes it possible to obtain an effect similar to the effect of supplementary note 1.

(Supplementary Note 13)

A recommendation system, including a recommendation device and a user terminal,
the recommendation device including:
   an extracting means that extracts a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the target company being indicated by input information obtained by the user terminal, the plurality of companies being cooperation candidates of the target company;
   a specifying means that specifies a first important part in the target company information and a second important part in cooperation candidate company information of the recommended company; and
   a presenting means that presents, to the user terminal, the cooperation candidate company information of the recommended company, the first important part, and the second important part,
the user terminal including:
   an input means that obtains the input information; and
   a displaying means that displays information presented by the presenting means.

The above configuration makes it possible to obtain an effect similar to the Effect of Supplementary Note 1.

[Additional Remark 3]

Further, some or all of the above example embodiments can also be described as below.

A recommendation device, including at least one processor, the processor carrying out:
an extracting process of extracting a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
a specifying process of specifying a first important part in the target company information and a second important part in cooperation candidate company information of the recommended company; and
a presenting process of presenting the cooperation candidate company information of the recommended company, the first important part, and the second important part.

Note that the recommendation device may further include a memory, which may store therein a program for causing the at least one processor to carry out the extracting process, the specifying process, and the presenting process. Further, the program can be stored in a non-transitory tangible storage medium that can be read by a computer.

### REFERENCE SIGNS LIST

1, 1A, 1B, 1C, 10C, 100: recommendation device
10, 10A, 10B: recommendation system
3, 3A, 3C: user terminal
11, 11A, 11B, 101: extracting section
12, 12A, 102: specifying section
13, 13A, 13C, 103: presenting section
31, 31C: input section
32, 32C: displaying section

What is claimed is:

1. A recommendation device, comprising at least one processor,
the at least one processor carrying out:
an extracting process of extracting a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
a specifying process of specifying a first important part in the target company information and a second important part in cooperation candidate company information of the recommended company; and
a presenting process of presenting the cooperation candidate company information of the recommended company, the first important part, and the second important part.

2. The recommendation device as set forth in claim 1, wherein:
the specifying process includes specifying a correspondence between the first important part and the second important part; and
the presenting process includes further presenting information indicative of the correspondence.

3. The recommendation device as set forth in claim 1, wherein the cooperation detail includes at least one selected from the group consisting of a name of the company, a description of business of the company, a service provided by the company, a product provided by the company, and a corporate philosophy of the company.

4. The recommendation device as set forth in claim 1, wherein the specifying process includes specifying the first important part and the second important part on the basis of an interword distance between each word included in the target company information and each word included in the cooperation candidate company information.

5. The recommendation device as set forth in claim 1, wherein the specifying process includes specifying the first important part and the second important part on the basis of a level of importance of each word included in the target company information and a level of importance of each word included in the cooperation candidate company information.

6. The recommendation device as set forth in claim 1, wherein:
the extracting process includes extracting the recommended company with reference to information outputted from a trained model that receives input of the target company information and the cooperation candidate company information; and
the specifying process includes specifying the first important part and the second important part on the basis of a part to which the trained model pays attention in the target company information and a part to which the trained model pays attention in the cooperation candidate company information.

7. The recommendation device as set forth in claim 1, wherein the extracting process includes extracting, as the recommended company, a company other than a competitor company of the target company, with reference to company information of each of the plurality of companies.

8. The recommendation device as set forth in claim 1, wherein the presenting process includes displaying the target company information and the cooperation candidate company information on a display device such that (i) the first important part and a part other than the first important part are displayed in respective different display modes in the target company information and (ii) the second important part and a part other than the second important part are displayed in respective different display modes in the cooperation candidate company information.

9. The recommendation device as set forth in claim 1, wherein the presenting process includes displaying the first important part and the second important part on a display device such that a display mode of the first important part and a display mode of the second important part correspond to each other.

10. A recommendation method, comprising steps carried out by a recommendation device, the steps being the steps of:
extracting a recommended company recommended as a cooperation candidate of a target company, from a plurality of companies on the basis of (i) target company information including a cooperation detail desired by the target company and (ii) cooperation candidate company information including a cooperation detail desired by each of the plurality of companies, the plurality of companies being cooperation candidates of the target company;
specifying a first important part in the target company information and a second important part in cooperation candidate company information of the recommended company; and
presenting the cooperation candidate company information of the recommended company, the first important part, and the second important part.

11. (canceled)

12. (canceled)

13. A recommendation system, comprising the recommendation device recited in claim 1 and a user terminal,
the user terminal carrying out:
an input process of obtaining the input information; and
a displaying process of displaying information presented by the presenting process.
